(19) United States
(12) Patent Application Publication
(10) Pub. No.: US 2015/0161633 A1
(43) Pub. Date: Jun. 11, 2015

(54) TREND IDENTIFICATION AND REPORTING

(71) Applicant: Asurion, LLC, Nashville, TN (US)

(72) Inventors: Cory Adams, San Antonio, TX (US); Jeffrey Rhines, San Antonio, TX (US); Richard Reybok, Half Moon Bay, CA (US)

(73) Assignee: Asurion, LLC, Nashville, TN (US)

(21) Appl. No.: 14/099,771

(22) Filed: Dec. 6, 2013

(51) Int. Cl. G06Q 30/02; G06Q 50/00

(52) U.S. Cl. CPC G06Q 30/0204; G06Q 50/01

(57) ABSTRACT

Technologies related to data analysis and reporting are disclosed. Data is gathered from multiple social media sources, including gathering data related to issues that users are experiencing related to the use of a deployed device. Trending data is identified based at least in part on an analysis of the gathered data. The trending data is classified into categories. Data similarity between the trending data in a respective category is measured to create groups. Groups and information related to issues associated with a given group are reported.

### FIELD

This patent document generally relates to data analysis and reporting.

### BACKGROUND

Problems with deployed devices may be handled by a support team. The problems can be grouped by common characteristics as well as the specific system or product (e.g., a deployed device) with which they are associated. For example, a deployed device can have an issue that is reported by several users at one time or in a short period of time.

### SUMMARY

This document describes, among other things, technologies relating to trend identification and reporting. In one aspect, a described technique includes gathering data from multiple social media sources, including gathering data related to issues that users are experiencing related to the use of a deployed device. Trending data is identified based at least in part on an analysis of the gathered data. The trending data is classified into categories. Data similarity between the trending data in a respective category is measured to create groups. Groups and information related to issues associated with a given group are reported.

These and other implementations may include one or more of the following features. Gathering data can include scraping social media sources, including scraping blogs, forums and other social interaction sites for posts that indicate an issue with a deployed device. The method can further include scraping threads from a social media source to identify question/answer pairs, and the method can further include, for a given issue that is identified as trending, reporting top-ranked answers as a potential solution to the trending issue. Identifying trending data can include identifying common issues across the multiple social media sources related to issues with deployed devices. Identifying trending data can include identifying a baseline for a given social media source, evaluating new posts to the social media source including extracting a title of a respective post, storing occurrences of significant terms in the respective post, and comparing an accumulation of the occurrences of the significant terms over time to occurrences that are associated with the baseline to identify trending data. The significant terms can be bigrams. Identifying trending data can include one or more of evaluating a number of views per post, evaluating a number of comments per post or a forum standing of a user that made a post when identifying trending data. Classifying the trending data into categories can include identifying ticketing categories for issues associated with the deployed devices, and classifying the trending data can further include classifying the trending data into the ticketing categories. Reporting groups can include reporting trending groups in each category including answers that are associated with a given issue for resolving same. Reporting groups can further include presenting an interface including a discovery tool for surfacing trending issues and for evaluating trending data including associated answers. Reporting groups can further include providing a user interface that includes controls for exploring top trending issues, groupings, top trending issues in groups or original posts associated with trending issues. Reporting groups can include presenting trend data for one or more issues including metrics for determining how far outside a predetermined normal distribution a specific bigram associated with an issue occurred. Presenting trend data can further include presenting one or more of term frequency, probability of a post belonging to a specific thread or being associated with a specific issue, last appearance in a thread or mean term frequency. The method can further include providing trending data and associated answers to a help service for use in assisting users with problems with deployed devices. Gathering can include scraping predetermined websites that contain posts that include descriptions of issues with deployed devices, their associated symptoms and one or more problem statements, and evaluating scraped data to identify significant terms that characterize a given post. The method can further include applying one or more rules, text processing and machine learning to scraped data to classify thread posts as issues. Identifying trending data can further include categorizing posts and threads gathered, identifying topics based at least in part on the categorizing, and identifying similarities among the topics to join the topics and produce trending issues. Reporting groups can include reporting an issue to a customer that is an owner of a deployed device.

Particular configurations of the technology described in this document can be implemented so as to realize none, one or more of the following potential advantages. Technical support personnel can be provided with a resource for identifying issues with their products/services (e.g., deployed devices) that users are discussing in social media, e.g., prior to receiving a heavy call volume. Early warning can provide technical support groups with time to identify, investigate, and mitigate issues prior to receiving significant customer inquiries regarding a trending issue.

Details of one or more implementations of the subject matter described in this document are set forth in the accompanying drawings and the description below. Other features, aspects, and potential advantages of the subject matter will become apparent from the description, the drawings, and the claims.

### BRIEF DESCRIPTION OF THE DRAWINGS

FIG. 1 shows a diagram of an example of a system for identifying trends associated with deployed devices in a community.

FIG. 2 shows a more detailed diagram of the system of FIG. 1.

FIG. 3 is a diagram of an example graph showing a threshold for identifying trending of terms with a term frequency.

FIG. 4 is a diagram of an example system for classifying trending data into categories.

FIG. 5 shows an example of a user interface for viewing tending information.

FIG. 6 is a flow diagram of an example process for reporting trending information.

FIG. 7 is a schematic diagram of an example of a generic computer system.

Like reference symbols in the various drawings indicate like elements.

### DETAILED DESCRIPTION

This disclosure identifies methods, systems, apparatus and techniques for surfacing information associated with topics that are trending. For example, support teams can use the information to assess problems with deployed devices that have not been reported directly but are already being discussed by users, e.g., in online blogs, forums and other social interaction sites. In some implementations, data can be gathered from multiple social media sources. The gathered data can be related to issues that users are experiencing related to the use of a deployed device. Trending data can be identified based, at least in part, on an analysis of the gathered data, and the trending data can be classified into categories. Data similarity between the trending data in a respective category can be measured to create groups. Groups and information related to issues associated with a given group can be reported, e.g., in a user interface used by the support teams or other users.

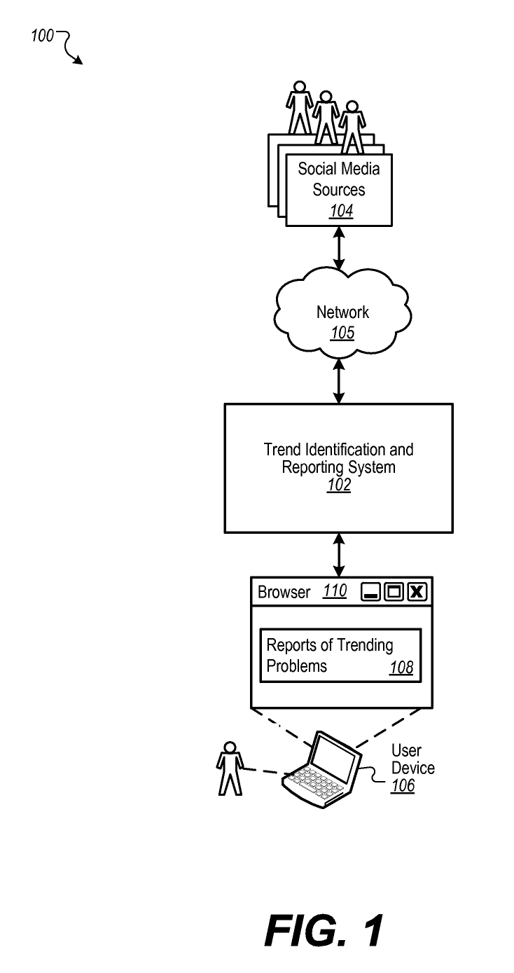

FIG. 1 shows a diagram of an example of a system 100 for identifying trends associated with products (e.g., deployed devices) or services in a community. In some implementations, the system 100 includes a trend identification and reporting system 102 that gathers data from multiple social media sources 104, e.g., using a network 105. For example, the gathered data can include data that is associated with issues that users are experiencing related to the use of a deployed device. The users in this example can be users who are part of a community of users who own and/or use products or services and who may communicate problems or other information related to the products or services in social media, e.g., including social networks, blogs, forums, bulletin boards, chat rooms, and other public sources of information.

Using the gathered data, the trend identification and reporting system 102 can identify trending data based at least in part on an analysis of the gathered data. The trending data can be classified into categories, and data similarity can be measured between the trending data in a respective category in order to create groups. The trend identification and reporting system 102 can report the groups and information related to issues associated with a given group. In some implementations, reports can be provided to a user device 106, e.g., for presentation of trending reports 108 in a browser 110. Other ways of producing the trending reports are possible, e.g., providing trending reports on one or more resources (e.g., webpages) and accessible to a user over the network 105. In some implementations, the network 105 can include wide area networks (WANs), local area networks (LANs), the Internet, other wired and wireless networks, and combinations thereof.

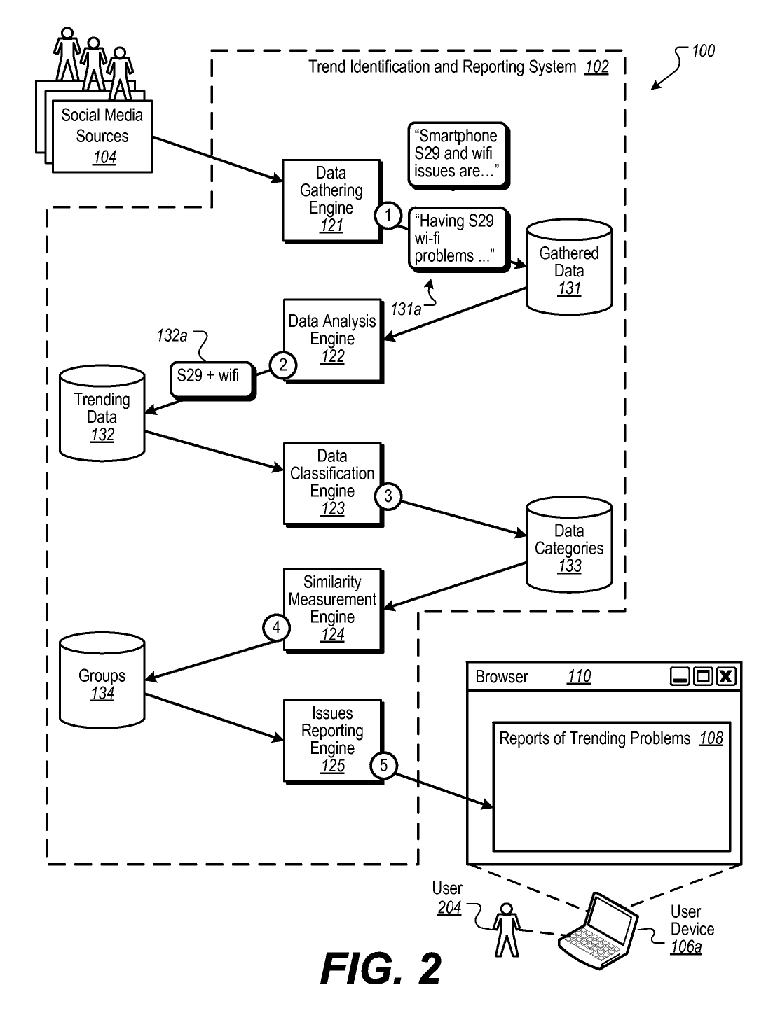

FIG. 2 shows a more detailed diagram associated with the system 100 of FIG. 1. For example, FIG. 2 shows plural stages that can be used by the trend identification and reporting system 102 to gather data from the social media sources 104 to produce the trending reports 108. In some implementations, the trend identification and reporting system 102 can include plural engines 121-125, each of which can be involved in the plural stages.

At stage 1, for example, a data gathering engine 121 can gather data from multiple social media sources 104. The data that is gathered can include, for example, data related to issues that users are experiencing related to the use of a deployed device, such as a cellular telephone of a particular model. In some implementations, gathering the data from the social media sources 104 can include scraping blogs, forums and other social interaction sites for posts that indicate an issue with the deployed device. For example, the data can be gathered from one or more social networking sites on which users are discussing problems, e.g., related to a particular deployed device (e.g., a smartphone S29), or to other products or services. In some implementations, the scraping can include scraping threads from a social media source to identify question/answer pairs. For example, gathered data 131a can include user-reported problems and solutions related to the smartphone S29 and further associated with wifi issues. In some implementations, the data gathering engine 121 can store the user-reported problems and solutions (and other gathered data) in the data store of gathered data 131. In some implementations, the importance of (e.g., rankings associated with) “useful” question/answer posts can be elevated above those of typical chatter associated with a product.

In some implementations, gathering the data from the social media sources 104 can include gathering information from plural different social media sources 104 and gathering information about a number of views per post from a specific social media source, a number of comments per post, or a forum standing of a user that made a post. This additional gathered information can also be stored with the gathered data 131, e.g., for later use in identifying trending data, as described below.

At stage 2, for example, a data analysis engine 122 can identify trending data based, at least in part, on an analysis of the gathered data. For example, identifying the trending data can include identifying common issues across plural ones of the multiple social media sources 104 related to issues with deployed devices. As an example, by analyzing occurrences/frequency of terms (e.g., S29 and wifi) identified from the gathered data 131a, the data analysis engine 122 can identify trending data 132a (e.g., S29+wifi) such as trending data that includes both terms associated with problems and solutions discussed by users on the social media sources 104. In some implementations, the data analysis engine 122 can store the trending data in the trending data 132. In some implementations, the data analysis engine 122 can handle different spellings/miss-spellings of a term (e.g., “wi-fi” and “wifi”) so that the different spellings/versions are grouped in the gathered data 131a.

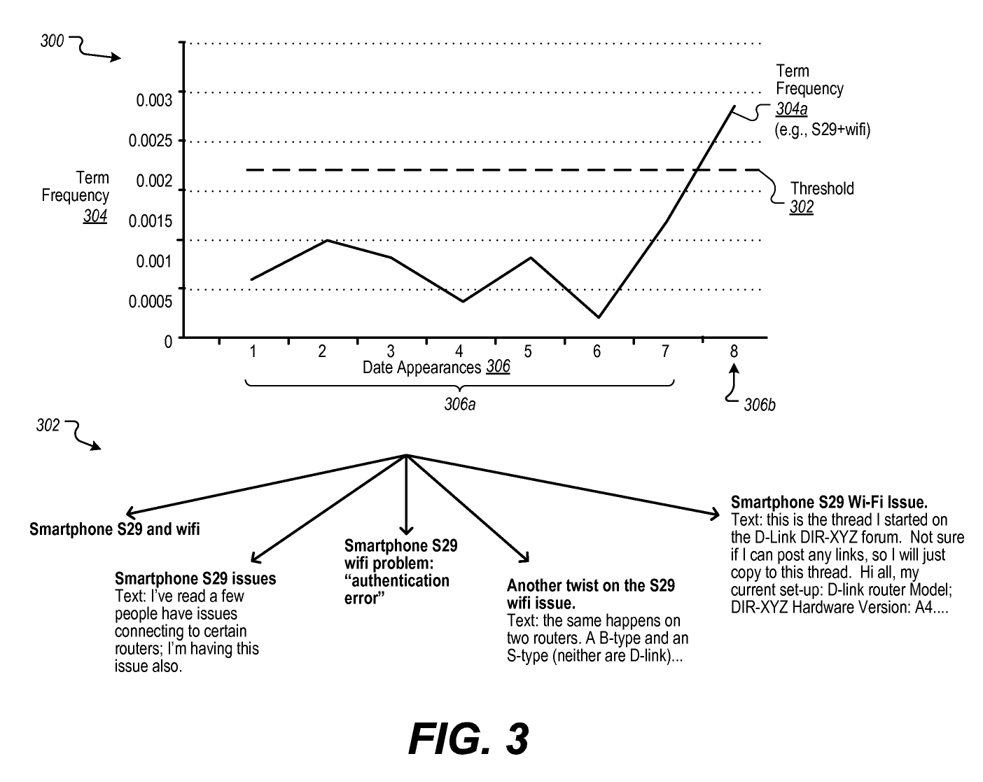

In some implementations, the data analysis engine 122 can identify a baseline for a given social media source 104 (e.g., a baseline of traffic related to a certain topic or device on the social media source), evaluate new posts to the social media source including extracting a title of a respective post, and store occurrences of significant terms in the new posts. The data analysis engine 122 can compare an accumulation of the occurrences of the significant terms over time to occurrences that are associated with the baseline activity to identify trending data. For example, a baseline, such as a count or occurrence rate, can exist for the terms S29 and wifi by users of a particular social network. The baseline in this example can represent an average amount of conversations associated with the terms, e.g., when no new trending problems exist. The data analysis engine 122 can evaluate new posts that are received that include the terms (e.g., S29+wifi) and extract titles of the respective posts, and store the significant terms (e.g., as bigrams, such as s29+wifi) of each respective post. Using the significant terms (e.g., s29+wi-fi), the data analysis engine 122 can compare an accumulation of posts received over time to the baseline. More detailed information for identifying trending data is provided below with reference to FIG. 3.

In some implementations, identifying trending data can include one or more of evaluating a number of views per post and evaluating a number of comments per post or a forum standing of a user that made a post when identifying trending data. For example, the data analysis engine 122 can count social network users who have viewed the post, count user comments against the post, or determine whether the user making the post has a small number or a large number of followers, or some other measure of the user's standing or influence.

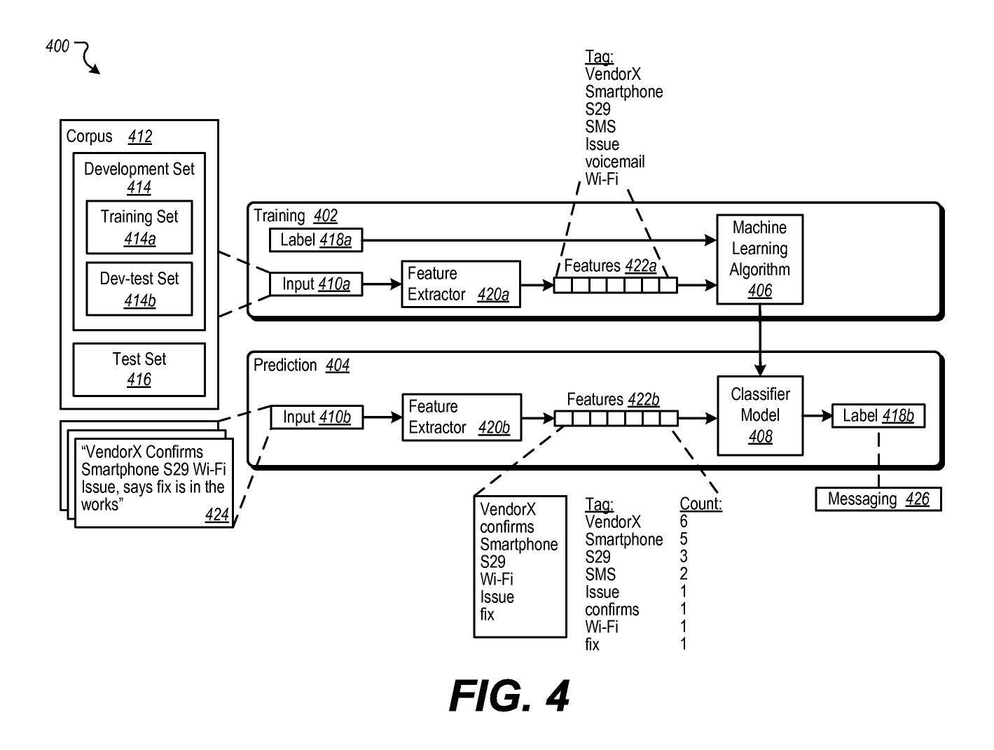

At stage 3, for example, a data classification engine 123 can classify the trending data 132 into data categories 133. In some implementations, the data classification engine 123 can store the data categories in the data categories 133. More detailed information for classifying trending data into categories is provided below with reference to FIG. 4.

At stage 4, for example, a similarity measurement engine 124 can measure data similarity between the trending data in a respective category to create groups. For example, within the data categories 133, the similarity measurement engine 124 can group data so as to provide clarity and to enhance the user experience, e.g., when the trending information is presented to a user. In some implementations, the similarity measurement engine 124 can perform preprocessing on all the text (e.g., including user questions and comments) of all posts prior to grouping by similarity. In some implementations, term frequencies associated with terms can be used, e.g., to create term frequency—inverse document frequency (TF-IDF) vectors. In some implementations, cosine similarities can be calculated between the posts. In a first pass, for example, for each measure in the matrix, if a similarity measure is above configured threshold, then the posts can be initially grouped together. In a second pass, for example, if a post is in more than one group, then the post can be assigned to the group in which it has the highest similarity. In some implementations, posts that were not assigned to a group using a method as described above can be grouped according to the trending bigrams that initially nominated the post. In some implementations, the similarity measurement engine 124 can store the groups in the data store of groups 134.

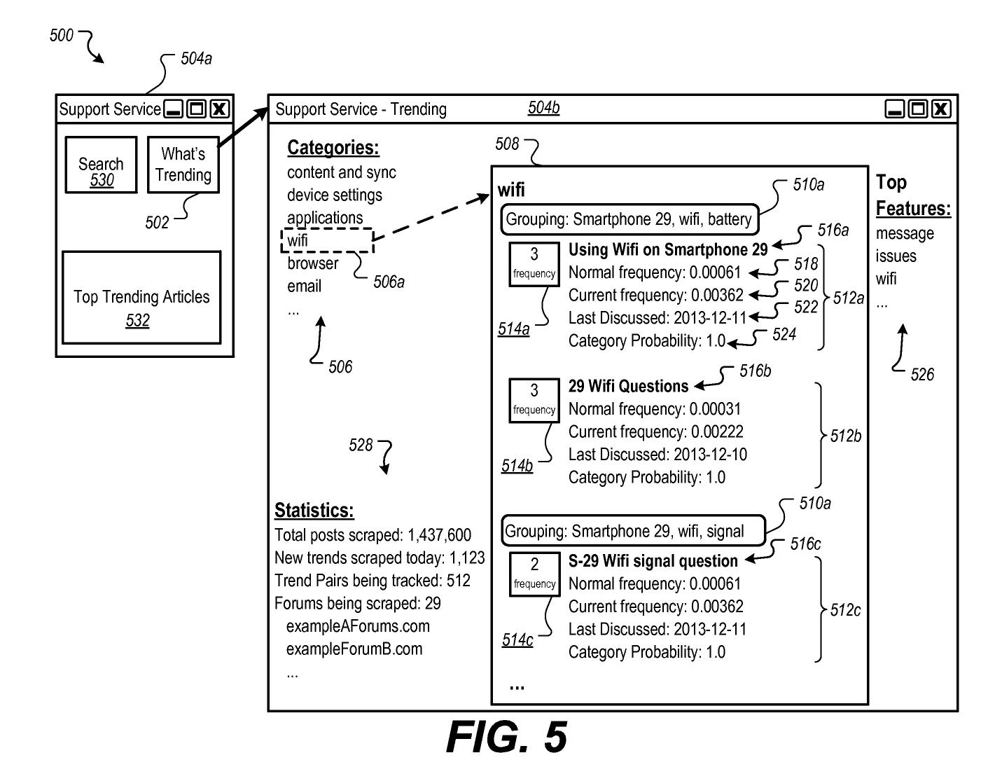

At stage 5, for example, a reporting engine 125 can report groups and information that are related to issues associated with a given group. For example, the reporting engine 125 can provide information to the user device 106 for presenting trending reports 108. A more detailed example of reported trend information is provided below with reference to FIG. 5.

FIG. 3 is a diagram of an example graph 300 showing a threshold 302 for identifying trend terms with a term frequency 304a. The graph 300 in this example has a data appearances x-axis 306 and a term frequency y-axis 304. The term frequency 304a in this example can represent a single topic, e.g., a bigram of “S29+wifi.” In this example, the line representing the term frequency 304a is below the threshold 302 for most of the graph, e.g., for the first seven days 306a. This can represent, for example, a baseline term frequency, e.g., when there are no new trending wifi problems/issues related to the smartphone 29 and discussion among users in social media sources 104 is at an average, every-day level. At an 8^{th} day 306b, for example, the line representing the term frequency 304a has moved above the threshold 302, signaling trending, for example, of “S29+wifi.” For example, scraping social media sources 104 on the 8^{th} day can discover a higher number of user posts associated with the smartphone S29 and wi-fi, such as user posts 308.

In some implementations, term frequencies associated with the term frequency y-axis 304 can be associated with other time intervals (e.g., other than days). For example, data from user posts can be gathered at hourly or other intervals and used to determine hourly (or other) trends. Other thresholds for identifying trends are possible.

In some implementations, some or all of the first seven days 306a can represent term frequencies obtained to establish a baseline, e.g., using historical data. For example, baselines can be daily or hourly baselines, or other time periods can be used. In some implementations, titles of posts can be extracted, and processing can occur on the remaining portions of the post, to extract a “bag-of-words”, e.g., un-ordered, lowercase collection of words, disregarding grammar and word order, and removing punctuation. In some implementations, bigrams (e.g., pairs of two terms) can be created by forming a Cartesian product of terms in the title. The Cartesian product, for example, can include unique bigrams, each having two different terms extracted from the title. Over time and on an on-going basis, bigrams can be tracked for all incoming posts. In some implementations, a count can be kept for each bigram (e.g., “S29+wifi”) being tracked and a current term frequency (e.g., the term frequency 304a) can be calculated. If a baseline frequency for the bigram is known (e.g., from historical data), then the term frequency 304a can be compared to the historical baseline to determine if trending is occurring. Otherwise, if the bigram's frequency is not available in historical data, then the current count (e.g., term frequency 304a) can be compared to the threshold 302 to determine if trending is occurring.

In some implementations, mathematical techniques can be used to determine trending. For example, a mean of the historical term frequency mean X̅ can be calculated as:

$$\overline{x} = \frac{{x}_{1} + {x}_{2} + … + {x}_{n}}{n} \qquad ( 1 )$$

where x₁ through xₙ are term frequencies for days 1 through n.

The standard deviation of the historical term frequency σₘₑₐₙ, for N days, can be calculated as:

$${σ}_{mean} = \frac{1}{\sqrt{N}} σ \qquad ( 2 )$$

In some implementations, a ratio based on the current term frequency, historical mean and standard deviation can be used to determine trending. For example, the ratio can be:

$$Ratio = \frac{Current term frequency}{Historical mean + ( Standard deviation * 3 )} \qquad ( 3 )$$

In some implementations, if the ratio is above a configurable threshold, the bigram, for example, is considered to be trending. When this occurs, for example, the trending bigrams can be gathered and passed to the post classification step.

FIG. 4 is a diagram of an example system for classifying trending data into categories. For example, the system 400 can be used in stage 3 described above with reference to FIG. 2.

In some implementations, the system 400 can include a training engine 402 and a prediction engine 404. The training engine 402, for example, can be used to train a machine learning algorithm 406 for use by a classifier model 408 in the prediction engine 404. For example, the prediction engine 404 can be used when the data classification engine 123 creates data categories 133 using trending data 132. The categories, for example, can apply to different subject areas for which trending data 132 exists.

The training engine 402, for example, can be used in supervised machine learning to classify the text of posts. For example, a supervised learning algorithm can analyze training data to produce an inferred function (e.g., the machine learning algorithm 406), which can be used for mapping new inputs, e.g., when the data classification engine 123 creates data categories 133 using trending data 132. In some implementations, input 410a can include a corpus 412 of training inputs, e.g., a development set 414 of text, including a training set 414a and a development set 414b. The development set 414, for example, can be used to develop the machine learning algorithm 406. The corpus 412 of training inputs can also include a test set 416, e.g., that can be used to test the machine learning algorithm 406. Supervised learning can require a training set of labels 418a, e.g., to be assigned to inputs by a user.

A feature extractor 420a, for example, can extract features 422a from input 410a. Using the extracted features 422a and the training set of labels 418a, for example, the machine learning algorithm 406 can produce the classifier model 408. Information in the classifier model 408, for example, can include features (e.g., words) and corresponding labels. In some implementations, algorithms used to create the classifier model 408 can include a multinomial naïve Bayesian algorithm. In some implementations, new trending posts identified during trend identification can be run through the model and assigned a probability per category, and subsequent posts analyzed using the model can be assigned a highest probability category.

The prediction engine 404 can receive, for example, input 410b in the form of user posts 424 from social media sources 104. A feature extractor 420b, for example, can extract features 422b from the input 410b. Using the extracted features 422b, the classifier model 408 can create labels 418b. In some implementations, information from the labels 418b can be used to provide messaging 426, to report on classifications that have been made.

In some implementations, repeated random sub-sampling validation techniques can be used for model validation (e.g., to validate the classifier model 408), and a classification report and a confusion matrix can be generated for each iteration. For example, a classification report can show a precision, a recall, and a score (e.g., an F1-score) for measuring accuracy after each iteration. In some implementations, an average of f1-scores can be used to produce an accuracy metric for the model. Over time, the accuracy can be expected to improve as more posts are classified.

In some implementations, a confusion matrix can identify how many posts were correct per category and which categories are being confused. The confusion matrix can also provide an ability to further refine the model based on identified confusion information and to identify possible feature overlap.

FIG. 5 shows an example of a user interface 500 for viewing tending information. For example, the user interface 500 can be used to view the trending report 108 described with respect to FIGS. 1 and 2. In some implementations, the user interface 500 can be used by customer support teams to prepare, for example, for issues that are being posted by users in social media sources 104 before the users begin formally submitting or reporting the issues to the support team.

The user interface 500 can include a “What's Trending?” control 502 that is selectable by a user from a support service screen 504a. The user may select the control 502 to become informed of new or existing trends, including to obtain information about the size and scope of a trending issue. In some implementations, instead of the user requesting the information in this way, trending information can be pushed to users, e.g., in the form of email messages or other forms of communication to identify trending issues.

In some implementations, selection of the “What's Trending?” control 502 can result in the presentation of a support service trending screen 504b in which trending information can be provided. For example, specific categories of trending information can be selectable by any of the categories 506. Upon selection of a category of interest 506a (e.g., messaging), for example, a trending information area 508 can present specific trending information related to the selected particular category of interest 506a.

Information in the trending information area 508 can be presented, for example, in groupings, e.g., groupings 510a and 510b, each representing a grouping of one or more of subjects of interest 512a-512c. For example, the groupings 510a can be used to report trending groups in each category including answers that are associated with a given issue for resolving same. In this example, the groupings 510a include the subjects of interest 512a and 512b.

In some implementations, subjects of interest 512a-512c can include frequency indicators 514a-514c, respectively, that include a number indicating a relative frequency of a topic. Each of the frequency indicators 514a-514c can provide, for example, a metric that indicates how far the current frequency (e.g., current frequency 520) is outside a normal distribution. Each of the subjects of interest 512a-512c can include titles 516a-516c, respectively, describing the subject and corresponding, e.g., to forums having substantially identical titles. The titles 516a-516c can each include terms from an associated bigram (e.g., S29+wifi). In some implementations, titles such as the title 516a can also serve as a selectable hyperlink for navigating to a source for the associated information, e.g., an online forum containing related posts.

In the example shown, the subject of interest 512a also includes a normal frequency 518 (e.g., indicating a baseline frequency), and a current frequency 520 (e.g., indicating a frequency higher than the normal frequency 518). The normal frequency 518, for example, can be a mean term frequency of all data points for the corresponding bigram used to select the subject of interest 512a. The current frequency 520, for example, can be the current term frequency for the bigram. The difference of the frequencies 518 and 520, for example, can be at least part of the reason that the associated subject of interest had been presented on the support service trending screen 504b. A last discussed date 522 can indicate, for example, the date on which users last discussed issues associated with the subject of interest, e.g., using the terms from the associated bigram. A category probability 524, for example, normalized to 1.0 (representing a 100% probability) can indicate a probability that the subject of interest 512a belongs to the category of interest 506a. Providing other information for a respective subject of interest 512a-512c is possible.

In some implementations, a top features area 526 can list top features for which information is accessible using the user interface 500. A statistics area 528 can present various statistics associated with the identified trends, e.g., a total number of posts processed, a count of the trends identified today, a number of trending pairs being tracked, or a number and identification of specific social media sources 104 (e.g., forums and other sources) that are being processed. Other statistics are possible.

In some implementations, the user interface 500 can include other controls and information. A search control 530 on the support service screen 504a, for example, can be used to locate specific trend information by using specific search terms and/or other inputs. A top trending articles area 532, for example, can list top-trending topics, each of which can display and/or provide access to information similar to the information presented in the subjects of interest 512a and 512b. Other controls and information are possible in the user interface 500.

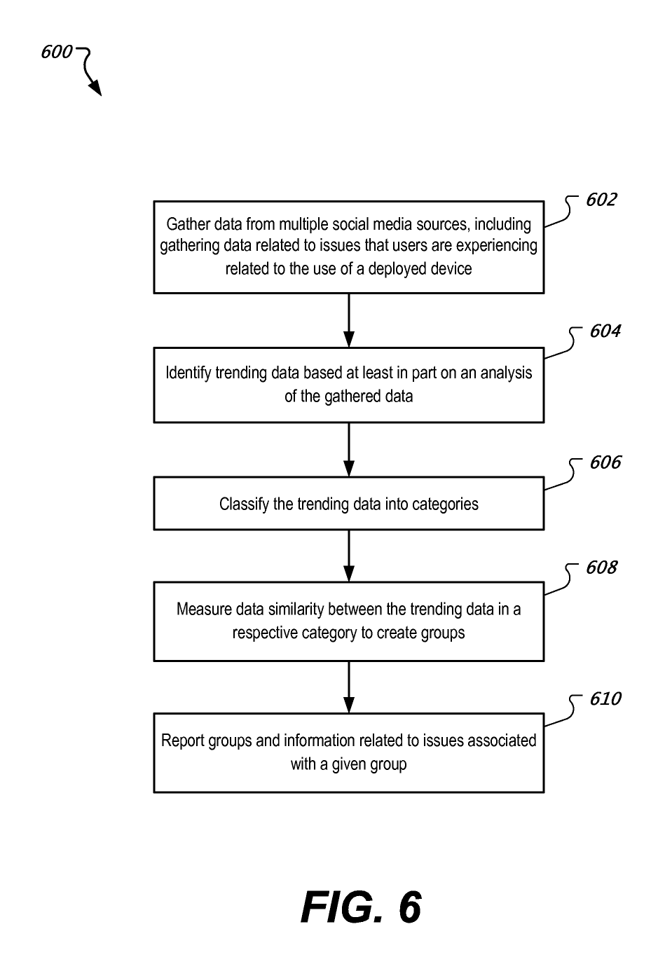

FIG. 6 is a flow diagram of an example process 600 for reporting trending information. For example, the process 600 can be used to report trending information for the system 100. FIGS. 1-5 are used to provide example structures for performing the steps of the process 600.

At 602, data is gathered from multiple social media sources, including gathering data related to issues that users are experiencing related to the use of a deployed device. As an example, the data gathering engine 121 can gather data from social media sources 104, as shown in conjunction with FIG. 2.

In some implementations, gathering data can include scraping predetermined websites that contain posts that include descriptions of issues with deployed devices, their associated symptoms and one or more problem statements, and evaluating scraped data to identify significant terms that characterize a given post. For example, the data gathering engine 121 can scrape posts from specific forums and other social sites where users report and share information (including solutions) about problems they are having with specific products or services. The scraping can include the identification of a specific deployed device, and data related to the subject of a given post.

In some implementations, the process 600 can further include further applying one or more rules, text processing and machine learning to scraped data to classify thread posts as issues. For example, the data gathering engine 121 can use a rule set for determining when posts in a forum (e.g., gathered data 131a), when treated together, are applicable to a particular issue.

At 604, trending data is identified based at least in part on an analysis of the gathered data. For example, the data analysis engine 122 can analyze the gathered data 131 to identify trending data 132, such as the trending data 132a (e.g., S29+wifi), as shown in conjunction with FIGS. 2 and 3.

In some implementations, identifying trending data can include identifying common issues across the multiple social media sources related to issues with deployed devices. For example, trends identified by the data analysis engine 122 can originate from multiple types and specific instances of social media sources 104.

In some implementations, identifying trending data can further include categorizing posts and threads gathered, identifying topics based at least in part on the categorizing, and identifying similarities among the topics to join the topics and produce trending issues.

At 606, the trending data is classified into categories. As an example, the data analysis engine 122 can identify and combine similar topics, such as topics that include terms that are synonymous or combinable for other reasons, as shown in conjunction with FIGS. 2 and 4.

In some implementations, classifying the trending data into categories can include identifying ticketing categories for issues associated with the deployed devices, and classifying the trending data can further include classifying the trending data into the ticketing categories. For example, the data classification engine 123 can identify and combine trending data 132 into data categories 133 that are likely to be handled together by a support team, such as a common issue or help desk ticket associated with a specific manufacturer and model of a deployed device.

At 608, data similarity between the trending data in a respective category is measured to create groups. For example, the similarity measurement engine 124 can measure similarities in the data categories 133 to identify groups 134, as described above with reference to FIG. 2.

At 610, groups and information related to issues associated with a given group are reported. As an example, the reporting engine 125 can provide information to the user device 106 for presenting trending reports 108. A more detailed example of reported trend information is provided below with reference to FIG. 5.

In some implementations, the process 600 can further include scraping threads from a social media source to identify question/answer pairs, and, for a given issue that is identified as trending, reporting top-ranked answers as a potential solution to the trending issue. As an example, a data gathering engine 121 can gather data question/answer pairs, problem/solution pairs, and/or other types of correlated information from posts from the multiple social media sources 104. The pairs can be ranked, for example, and presented with other trending information in the user interface 500.

In some implementations, reporting groups can further include presenting an interface, including a discovery tool for surfacing trending issues and for evaluating trending data including associated answers. For example, the user interface 500 can include the “What's Trending?” control 502 for providing the support service trending screen 504b in which specific trending information can be selected for presentation.

In some implementations, reporting groups can further include providing a user interface that includes controls for exploring top trending issues, groupings, top trending issues in groups, or original posts associated with trending issues. For example, the user interface 500 can provide the top trending articles area 532, the groupings 510a-510b, the subjects of interest 512a and 512b, and titles 516a-516c usable as hyperlinks to access original user posts.

In some implementations, reporting groups can include presenting trend data for one or more issues including metrics for determining how far outside a predetermined normal distribution a specific bigram associated with an issue occurred. For example, the subjects of interest 512a and 512b can include the frequency indicators 514a-514c and can provide, for example, a metric that indicates how far the current frequency (e.g., current frequency 520) is outside a normal distribution.

In some implementations, reporting groups can include reporting an issue to a customer that is an owner of a deployed device. For example, the system 100 can provide trending reports to users who own a particular deployed device (e.g., a Smartphone 29).

In some implementations, presenting trend data can further include presenting one or more of a term frequency, a probability of a post belonging to a specific thread or being associated with a specific issue, a last appearance in a thread, or a mean term frequency. For example, the 504b can include frequency indicators 514a-514c, category probabilities 524, last discussed dates 522, and normal frequencies 518, as described above with reference to FIG. 5.

In some implementations, the process 600 can further include providing trending data and associated answers to a help service for use in assisting users with problems with deployed devices. For example, the system 100 can provide trending reports 108 to support teams associated with the support of a particular deployed device.

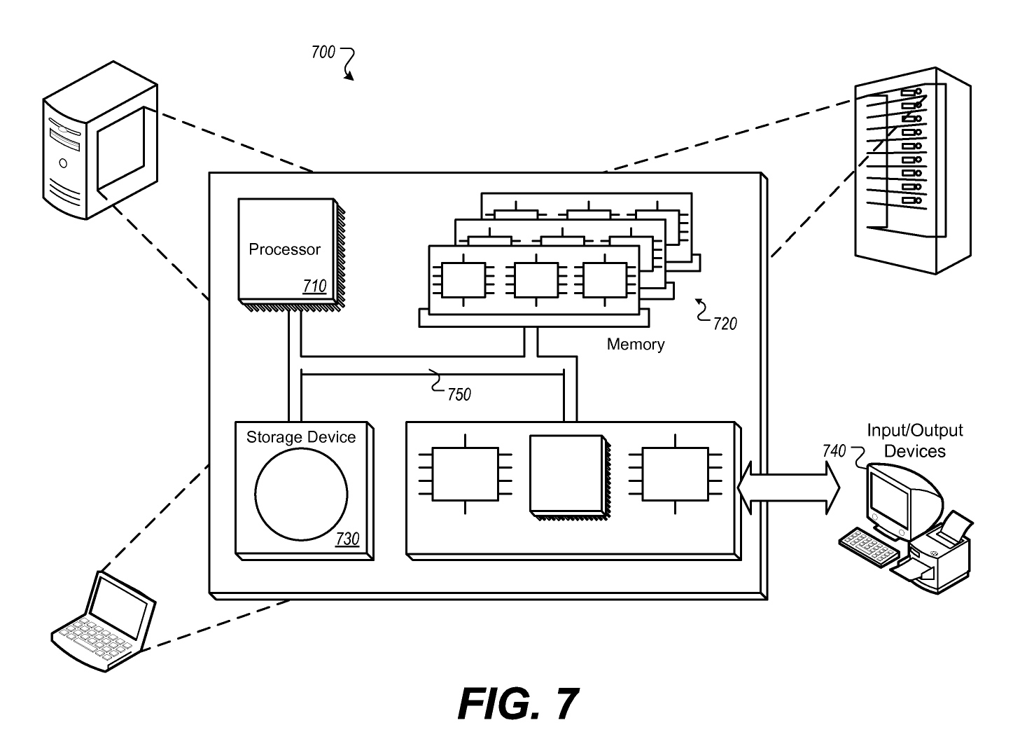

FIG. 7 is a schematic diagram of an example of a generic computer system 700. The system 700 can be used for the operations described in association with the method 600 according to one implementation. For example, the system 700 may be included in either or all of the trend identification and reporting system 102, the user device 106, and/or other components of the systems described above.

The system 700 includes a processor 710, a memory 720, a storage device 730, and an input/output device 740. Each of the components 710, 720, 730, and 740 are interconnected using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730 to display graphical information for a user interface on the input/output device 740.

The memory 720 stores information within the system 700. In one implementation, the memory 720 is a computer-readable medium. In one implementation, the memory 720 is a volatile memory unit. In another implementation, the memory 720 is a non-volatile memory unit.

The storage device 730 is capable of providing mass storage for the system 700. In one implementation, the storage device 730 is a computer-readable medium. In various different implementations, the storage device 730 may be a floppy disk device, a hard disk device, an optical disk device, or a tape device.

The input/output device 740 provides input/output operations for the system 700. In one implementation, the input/output device 740 includes a keyboard and/or pointing device. In another implementation, the input/output device 740 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

Although a few implementations have been described in detail above, other modifications are possible. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of embodiments of the invention have been described. Nevertheless, it will be understood that various modifications may be made without departing from the spirit and scope of the invention. Accordingly, other embodiments are within the scope of the following claims.

What is claimed is:

1. A computer implemented method for identifying trends associated with deployed devices in a community, the method comprising:
gathering data from multiple social media sources, including gathering data related to issues that users are experiencing related to the use of a deployed device, wherein gathering data includes scraping social media sources, including scraping blogs, forums and other social interaction sites for posts that indicate an issue with a deployed device; and wherein gathering data further includes scraping threads from a social media source to identify question/answer pairs;
identifying trending data based at least in part on an analysis of the gathered data;
classifying the trending data into categories;
measuring data similarity between the trending data in a respective category to create groups;
reporting groups and information related to issues associated with a given group including reporting, for a given issue that is identified as trending, top-ranked answers as a potential solution to the trending issue and reporting an issue to a customer that is an owner of a deployed device.

2. The method of claim 1 wherein identifying trending data includes identifying common issues across the multiple social media sources related to issues with deployed devices.

3. The method of claim 2 wherein identifying trending data includes identifying a baseline for a given social media source, evaluating new posts to the social media source including extracting a title of a respective post, storing occurrences of significant terms in the respective post, and comparing an accumulation of the occurrences of the significant terms over time to occurrences that are associated with the baseline to identify trending data.

4. The method of claim 3 wherein the significant terms are bigrams.

5. The method of claim 1 wherein identifying trending data includes one or more of evaluating a number of views per post, evaluating a number of comments per post or a forum standing of a user that made a post when identifying trending data.

6. The method of claim 1 wherein classifying the trending data into categories includes identifying ticketing categories for issues associated with the deployed devices, and wherein classifying the trending data further includes classifying the trending data into the ticketing categories.

7. The method of claim 1 wherein reporting groups includes reporting trending groups in each category including answers that are associated with a given issue for resolving same.

8. The method claim 1 wherein reporting groups further comprises presenting an interface including a discovery tool for surfacing trending issues and for evaluating trending data including associated answers.

9. The method of claim 1 wherein reporting groups further comprises providing a user interface that includes controls for exploring top trending issues, groupings, top trending issues in groups or original posts associated with trending issues.

10. The method of claim 1 wherein reporting groups includes presenting trend data for one or more issues including metrics for determining how far outside a predetermined normal distribution a specific bigram associated with an issue occurred.

11. The method of claim 10 wherein presenting trend data further includes presenting one or more of term frequency, probability of a post belonging to a specific thread or being associated with a specific issue, last appearance in a thread or mean term frequency.

12. The method of claim 1 further comprising providing trending data and associated answers to a help service for use in assisting users with problems with deployed devices.

13. The method of claim 1 wherein gathering includes scraping predetermined websites that contain posts that include descriptions of issues with deployed devices, their associated symptoms and one or more problem statements, and evaluating scraped data to identify significant terms that characterize a given post.

14. The method of claim 13 further comprising applying one or more rules, text processing and machine learning to scraped data to classify thread posts as issues.

15. The method of claim 1 wherein identifying trending data further comprises categorizing posts and threads gathered, identifying topics based at least in part on the categorizing, and identifying similarities among the topics to join the topics and produce trending issues.
